(19) United States
(12) Patent Application Publication
(10) Pub. No.: US 2022/0101746 A1
(43) Pub. Date: Mar. 31, 2022

(54) SET OF BOOKS FOR USE IN A CLASSROOM HAVING STUDENTS READING AT DIFFERENT GRADE LEVELS AND RELATED TEACHING METHOD

(71) Applicant: Teacher's Discovery Company, a dba of American Eagle Co., Inc, Auburn Hills, MI (US)

(72) Inventor: Bruce Carpenter McWilliams, Lake Orion, MI (US)

(73) Assignee: Teacher's Discovery Company, a dba of American Eagle Co., Inc, Auburn Hills, MI (US)

(21) Appl. No.: 17/038,817

(22) Filed: Sep. 30, 2020

(51) Int. Cl. G09B 17/00; G09B 21/00

(52) U.S. Cl. CPC G09B 17/006; G09B 21/006

(57) ABSTRACT

A set of books for use in a classroom having students reading at different grade levels. The set of books includes an original text novel edition printed in physical book form having a cover, numbered chapters and numbered pages each having a page layout and a first modified text version of the original text novel edition written at a first lower grade level reading range than the original text novel edition. The original and modified text editions are printed in physical book form having substantially the same size, cover, page layout and page numbering. The set of books can be marked with a subtle indicator enabling the teacher to identify the reading level of each book without providing noticeable indication of reading level to students in the class. A method of teaching language arts using the set books is also disclosed.

### TECHNICAL FIELD

The present disclosure relates set books for use in a classroom having students reading at different grade levels.

### BACKGROUND

A high number of students in classrooms are reading at levels significantly below their grade level. English Language Arts teachers tasked with teaching students to read are faced with the challenge of having students of varying reading levels in the same classroom. Separate reading classes for struggling students are no longer the norm. Teachers face two challenges:
1) Providing versions of the same book written for different levels
2) Avoiding the stigma (bullying) resulting from students using lower level books in the presence of other students.

In mentor based education, with actual teachers, the methodology is to have the students examine passages or chapters in class discussions led by the teacher asking questions of all the students. The entire class responds to questions about the same passage.

The difficulty in providing differentiated texts to challenged students is that the social milieu in school will result in those children reading simplified texts being labeled, ridiculed, even bullied, resulting in negative outcomes both in reading skill acquisition and self-esteem.

This solves the problem faced by hundreds of thousands of Reading Teachers in the US alone.

### SUMMARY

The disclosed set of books is for use in a classroom having students reading at different grade levels. The set of books includes an original text novel edition printed in physical book form having a cover, numbered chapters and numbered pages each having a page layout and a first modified text version of the original text novel edition written at a first lower grade level reading range than the original text novel edition. The original and modified text editions are printed in physical book form having substantially the same size, cover, page layout and page numbering. The covers are identical. The font and font size are identical. The amount of text on a page is the same or not visually obvious. The paragraphs dealing with a certain passage in the original all appear on the same numbered page and in the same position on that page.

By creating sets of readers at 3 levels, one the original work, and two others written at lower Lexile® levels, the teacher is able to have coordinated class discussions and simply put, an integrated class. A Lexile® measure is a numeric representation of an individual's reading ability or a text's readability or difficulty. Lexile® is a trademark of MetaMetric, Inc. of Durham, N.C. While the Lexile® system is well known in the United States for English language texts the claims are not to this scale and other methods of rating a text's readability can be utilized.

The set of textbooks distributed to the class should look alike to avoid bullying resulting from students using lower level books in the presence of other students. This problem effectively avoided by making the versions virtually undetectable by a unique series of constructs. The covers are identical. The font and font size are identical. The amount of text on a page is the same or not visually obviously different. The paragraphs dealing with a certain passage in the original all appear on the same numbered page and in the same position on that page

So that the teachers will know which book to hand out to which students, the set of books can be marked with a subtle indicator, such as the variation of placement of a simple dot on the spine of the books which indicates reading level. This enables the teacher to identify the reading level of each book without providing noticeable indication of reading level to students in the class.

The different version of the books have word counts similar enough not to noticeable indication of reading level to other students in the class. Preferably, the word count of first modified text version is within 5% of that of the original text novel edition and the word count of second modified text version is within 10% of that of the first modified text edition.

The different version of the books are written at different reading levels. The first modified text version is written at a grade level reading range which is at least one grade level below the original text novel edition. The second modified text version is written at a grade level reading range which is at least one grade level below the first modified text version.

Ideally, the set textbooks also includes copies of the original text novel edition, the first modified text version and the second modified text version, in e-book format. These e-books will have the same numbered pages as the original text novel edition so visually impaired students can follow a teacher's instruction to turn to a specific page in their book to discuss corresponding sections of the novel. The e-books preferably will comply with a technical standard for digital audiobooks named Digital Accessible Information System (DAISY) and/or the technical standard for digital audiobooks named ANSI/NISO Z39.86-2005 issued by the American National Standards Institute.

A method of teaching language arts using the set books is also disclosed. A method of teaching language arts, includes the steps of:
providing at least one original text novel edition printed in physical book form having a cover, numbered chapters and numbered pages;
providing at least one first modified text version of the original text novel edition printed in physical book form written at at least one grade below that of the original text novel edition, having substantially the same size, cover and numbered pages as the original text novel edition, and having a word count within 5% of the original text novel edition;
distributing the original text novel editions and modified text version books to students in a classroom based their reading level; and
simultaneously conducting a classroom exercises with students reading of different grade levels with each having an appropriate reading level book, enabling all the students to participate in class and follow a teacher's instruction to turn to a specific page in their book to discuss corresponding sections of the novel.

This set of books and teaching method solves a real problem faced by hundreds of thousands of Reading Teachers in the US.

### BRIEF DESCRIPTION OF THE DRAWINGS

FIG. 1 illustrates a set of textbooks with an original text, a middle level, and a lower level version having a subtle dot on the spine of the books enabling the teacher to identify the reading level of each book without providing noticeable indication of reading level to students in the class.

FIG. 2 is a sample page from an original text novel edition printed in physical book form showing the page layout and page numbering;

FIG. 3 is a sample page from a first modified text version of the original text novel edition written at a lower grade level reading range lower than the original text novel edition; and

FIG. 4 is a sample page from second modified text version of the original text novel edition written at a lower grade level reading range lower than the first modified text version.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

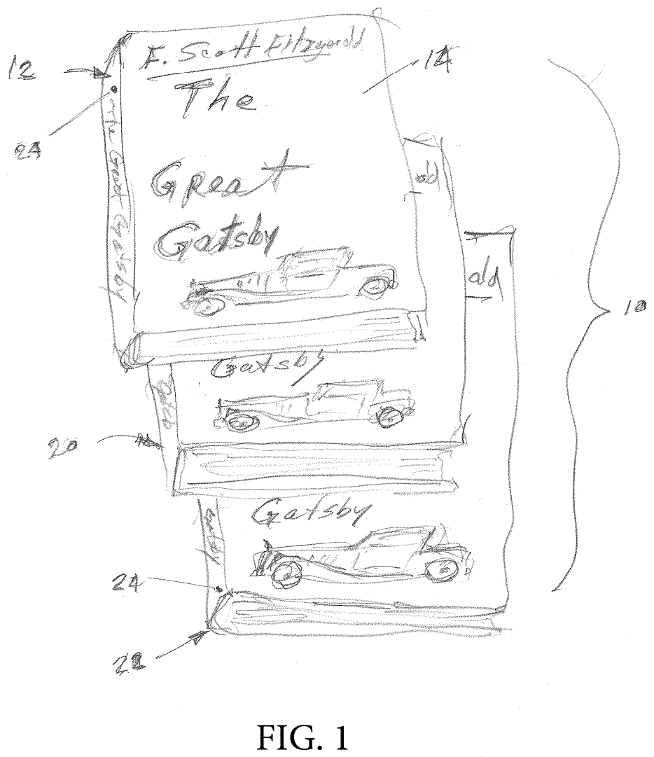

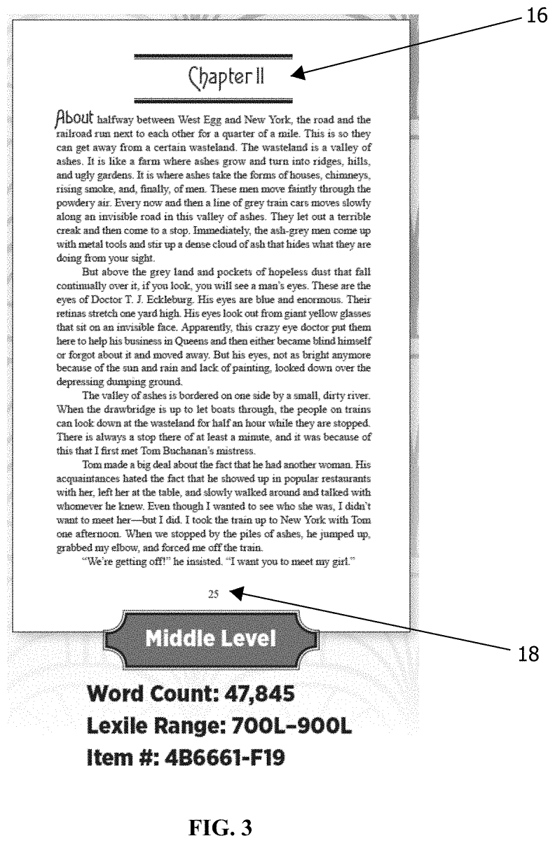

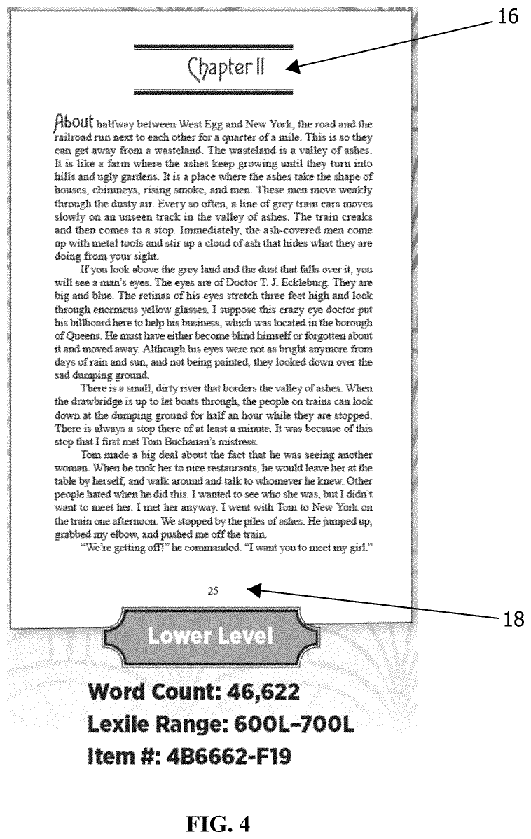

The set books 10 is for use in a classroom having students reading at different grade levels is described with reference to the sample textbook pages shown in FIGS. 1-4. The book in the exemplary embodiment is “The Great Gatsby” by F. Scott Fitzgerald a classic text commonly used in high school English literature class.

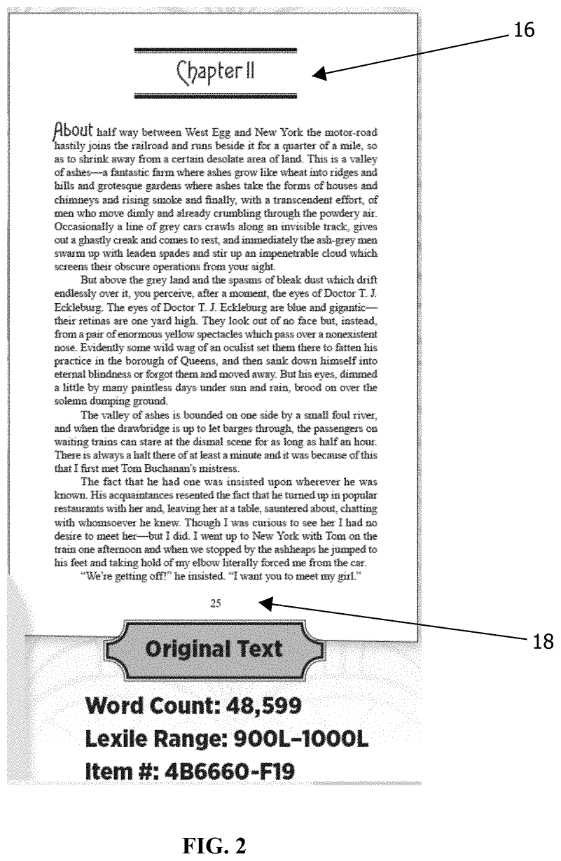

The set of books includes an original text novel edition 12 printed in physical book form having a cover 14, numbered chapters 16 and numbered pages 18 each having a page layout. A first modified text version 20 of the original text novel edition written at a first lower grade level reading range than the original text edition 12. The original 12 and modified text editions 20 and 22 are printed in physical book form having substantially the same size, cover, page layout and page numbering. The covers are identical. The font and font size are identical. The amount of text on a page is the same or not visually obviously different. The paragraphs dealing with a certain passage in the original all appear on the same numbered page and in the same position on that page. As shown in the sample pages in FIGS. 2-4.

The set of textbooks includes at least two versions, the original text version and a version written at a lower reading level. Preferably by creating sets of readers at 3 levels, one the original work 12, and two others written at different lower Lexile® levels 20 and 22, the teacher is able to have coordinated class discussions with students having much different reading ability.

The set of textbooks distributed to the class should look alike, as shown in FIGS. 1-4, to avoid bullying of students using lower level books in the presence students reading the original version. This problem effectively avoided by making the versions virtually undetectable by a unique series of constructs. The covers are identical. The font and font size are identical. The amount of text on a page is the same or not visually obviously different. The paragraphs dealing with a certain passage in the original all appear on the same numbered page and in the same position on that page in the lower reading level versions.

The textbooks marked with a subtle indicator so that the teachers will know which book to hand out to which students. The subtle indicator can be the variation of placement of a simple dot 24 on the spine of the books which indicates reading level. This enables the teacher to identify the reading level of each book without providing noticeable indication of reading level to students in the class look at the cover. The different version of the books have word counts similar enough not to noticeable indication of reading level to other students in the class. Preferably, the word count of first modified text version is within 5% of that of the original text novel edition and the word count of second modified text version is within 10% of that of the first modified text edition.

The different version of the books are written at different reading grade levels. The first modified text version 20 is written at a grade level reading range which is at least one grade level below the original text edition 12. The second modified text version 22 is written at least one a grade level below that of the first modified text version, 18. In the illustrated embodiment the original version is rated at a Lexile® 900L-1000L, the middle level version is written at a Lexile® 700L-900L and the lower level version is written at a Lexile® 600L-700L.

The word count of the different versions are similar enough so as to not provide noticeable indication of reading level to other students in the class. Preferably, the word count of first modified text version is within 5% of that of the original text edition and the word count of second modified text version is within 10% of that of the original text edition and 5% of the first modified text version.

Ideally the set of textbooks includes copies of the original text novel edition, the first modified text version and the second modified text version, in e-book format having the same numbered pages as the original text novel edition so visually impaired students can follow a teacher's instruction to turn to a specific page in their book to discuss corresponding sections of the novel.

The e-books preferably comply with a technical standard for digital audiobooks named Digital Accessible Information System (DAISY) or the technical standard for digital audiobooks named ANSI/NISO Z39.86-2005 issued by the American National Standards Institute.

The set of textbooks written at different reading levels facilitates the implementation of a new method of teaching language arts. The teacher can provide at least one original text novel edition printed in physical book form having a cover, numbered chapters and numbered pages to students in the class reading at grade level. The teacher can provide at least one first modified text version of the original text novel edition written at at least one grade reading level below to other students in the class reading at a lower grade level than the original text novel edition. The first modified text version is printed in physical book form having substantially the same size, cover and numbered pages as the original text novel edition, and having a word count within 5% of the original text novel edition;

Preferably the teacher is provided with a second modified text version of the original text novel editions, so the teacher can distribute the second modified text version books to students in the same classroom reading level at least one grade reading level below the students in the class reading at the first modified text novel edition. The second modified text version is printed in physical book form having substantially the same size, cover and numbered pages as the original text novel edition, and having a word count within 5% of the first modified text novel edition.

Having students in the class with appropriate reading level edition of the same textbook enables the teacher to simultaneously conduct a classroom exercises with students reading of different grade levels with each having an appropriate reading level book. This enables all the students to participate in class and follow a teacher's instruction to turn to a specific chapter or page in their book to discuss corresponding sections of the novel.

In order to enable teachers to easily distribute different level textbooks in class, the set of books are marked are marked with a subtle indicator enabling the teacher to identify the reading level of each book without providing noticeable indication of reading level to students in the class.

In classrooms having students with visually impairments the teacher can provide at least one of: the original text novel edition, the first modified text version and the second modified text version, in e-book format to enable the visually impaired student to effectively participate in the classroom with other students. The e-book has the same numbered pages as the original text novel edition so visually impaired students can follow a teacher's instruction to go to a specific page in their book to discuss corresponding sections of the novel.

Preferably the e-books provided to the students comply with a technical standard for digital audiobooks named ANSI/NISO Z39.86-2005 issued by the American National Standards Institute or that of the technical standard for digital audiobooks named ANSI/NISO Z39.86-2005 issued by the American National Standards Institute.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A set of books for use in a classroom having students reading at different grade levels, the set books comprising:
at least one original text novel edition printed in physical book form having a cover, numbered chapters and numbered pages each having a page layout;
at least one first modified text version of the original text novel edition written at a first lower grade level reading range than the original text novel edition, printed in physical book form having the same size, cover, page layout and page numbering as the original text novel edition; and
at least one second modified text version of the original text novel edition written at a second lower grade level reading range than the first modified text version, printed in physical book form having the same size, cover, page layout and page numbering as the original text novel edition;
wherein the set of books are capable of being distributed to students in a classroom based their reading level, enabling all the students to participate in class and follow a teacher's instruction to turn to a specific page in their book to discuss corresponding sections of the novel.

2. The set of books of claim 1, wherein a word count of first modified text version is within 5% of that of the original text novel edition.

3. The set of books of claim 1, wherein a word count of second modified text version is within 10% of that of the original text novel edition.

4. The set of books of claim 1, wherein the set of books are marked with a subtle indicator enabling the teacher to identify a reading grade level of each book without providing noticeable indication of reading grade level to students in the class.

5. The set of books of claim 1, wherein the first modified text version has a grade level reading range of at least one grade level below the original text novel edition.

6. The set of books of claim 1, wherein the second modified text version has a grade level reading range of at least one grade level below the first modified text version.

7. The set of books of claim 1, further comprising copies of at least one of: the original text novel edition, the first modified text version and the second modified text version, in e-book format having the same numbered pages as the original text novel edition so visually impaired students can follow a teacher's instruction to turn to a specific page in their book to discuss corresponding sections of the book.

8. The set of books of claim 7, wherein the e-book complies with a technical standard for digital audiobooks named Digital Accessible Information System (DAISY).

9. The set of books of claim 7, wherein the e-book complies with a technical standard for digital audiobooks named ANSI/NISO Z39.86-2005 issued by the American National Standards Institute.

10. A set of books for use in a classroom having students reading at different grade levels, the set books comprising:
at least one original text novel edition printed in physical book form having a cover, numbered chapters, page layout and page numbering; and
at least one first modified text version of the original text novel edition written at a first lower grade level reading range at least one grade below that of the original text novel edition, printed in physical book form having the same size, cover and numbered pages as the original text novel edition, and having a word count within 5% of the original text novel edition;
wherein the books are capable of being distributed to students in a classroom based their reading level, enabling all the students to participate in class and follow a teacher's instruction to turn to a specific page in their book to discuss corresponding sections of the novel.

11. The set of books of claim 10, wherein the set of books are marked with a subtle indicator enabling the teacher to identify the reading grade level of each book.

12. The set of books of claim 10, further comprising:
at least one second modified text version of the original text novel edition written at a second lower grade level reading range at least one grade below that of the first modified text version, printed in physical book form having the same size, cover and numbered pages as the original text novel edition and having a word count within 10% of the original text novel edition.

13. The set of books of claim 12, wherein the word count of the second modified text version has a word count within 5% of the word count of the first modified text version.

14. The set of books of claim 10, further comprising copies of at least one of the original text novel edition, the first modified text version, in e-book format having the same numbered pages as the original text novel edition so visually impaired students can follow a teacher's instruction to turn to a specific page in their book to discuss corresponding sections of the novel.

15. The set of books of claim 14, wherein the e-book complies with a technical standard for digital audiobooks named ANSI/NISO Z39.86-2005 issued by the American National Standards Institute.

16. A method of teaching language arts, comprising:
providing at least one original text novel edition printed in physical book form having a cover, numbered chapters and numbered pages; and
providing at least one first modified text version of the original text novel edition written at a lower level reading range at least one grade below that of the original text novel edition, printed in physical book form having the same size, cover and numbered pages as the original text novel edition, and having a word count within 5% of the original text novel edition;
distributing the original text novel editions and modified text version books to students in the same classroom based their reading level; and
simultaneously conducting a classroom exercises with students reading of different grade levels with each having an appropriate reading level book, enabling all the students to participate in class and follow a teacher's instruction to turn to a specific page in their book to discuss corresponding sections of the novel.

17. The method of teaching language arts of claim 16, further comprising:
providing at least one second modified text version of the original text novel edition written at a second lower grade level reading range at least one grade below that of the first modified text version, printed in physical book form having the same size, cover and numbered pages as the original text novel edition, and having a word count within 5% of the first modified text version.

18. The method of teaching language arts of claim 17, wherein the provided set of books are marked with a subtle indicator enabling the teacher to identify the reading level of each book without providing noticeable indication of reading level to students in the class.

19. The method of teaching language arts of claim 17, further comprising:
providing at least one of: the original text novel edition, the first modified text version and the second modified text version, in e-book format having the same numbered pages as the original text novel edition to visually impaired students so they can follow a teacher's instruction to turn to a specific page in their book to discuss corresponding sections of the book.

20. The method of teaching language arts of claim 19, wherein the e-book complies with a technical standard for digital audiobooks named ANSI/NISO Z39.86-2005 issued by the American National Standards Institute.
